(19) United States
(12) Patent Application Publication
(10) Pub. No.: US 2026/0317602 A1
(43) Pub. Date: Oct. 15, 2026

(54) FORMALEDHYE-FREE ADHESIVE COMPOSITIONS AND METHODS OF USING THE SAME FOR ADHESION OF LIGNOCELLULOSIC MATERIALS

(71) Applicant: SOLENIS TECHNOLOGIES, L.P., Wilmington, DE (US)

(72) Inventors: Michael J. Birkeland, Mount Horeb, WI (US); Cecil Coutinho, Wilmington, DE (US)

(73) Assignee: SOLENIS TECHNOLOGIES, L.P., Wilmington, DE (US)

(21) Appl. No.: 19/466,674

(22) Filed: Feb. 2, 2026

Related U.S. Application Data
(60) Provisional application No. 63/755,370, filed on Feb. 7, 2025.

(51) Int. Cl. C09J 199/00; C09J 5/06; C09J 11/08

(52) U.S. Cl. CPC C09J 199/00; C09J 5/06; C09J 11/08; C09J 2400/306

(57) ABSTRACT

Adhesive compositions, methods of forming the adhesive compositions, composite articles comprising cured adhesives formed from the adhesive compositions, and methods of forming the composite articles are provided herein. In an embodiment, an adhesive composition comprises a protein component, an azetidinium functionalized polymer, and an alkylene (meth)acrylic acid copolymer. The adhesive composition is substantially free of formaldehyde. A method of forming an adhesive composition that is substantially free of formaldehyde comprises combining a protein component, an azetidinium functionalized polymer, and an alkylene (meth)acrylic acid copolymer. A method of forming a composite article comprises providing a lignocellulosic material; applying a protein component, an azetidinium functionalized polymer, and an alkylene (meth)acrylic acid copolymer to the lignocellulosic material to form a lignocellulosic material/adhesive combination; and subjecting the lignocellulosic material/adhesive combination to heat and pressure to form the composite article.

### CROSS-REFERENCE TO RELATED APPLICATIONS

This application claims the benefit of U.S. Provisional Application No. 63/755,370, filed Feb. 7, 2025, the entire contents of which are hereby incorporated by reference.

### TECHNICAL FIELD

The present disclosure generally relates to formaldehyde-free adhesive compositions, methods of forming the adhesive compositions, composite articles comprising cured adhesives formed from the adhesive compositions, and methods of forming the composite articles. The present disclosure more particularly relates to formaldehyde-free adhesives used to adhere lignocellulosic materials in composite articles.

### BACKGROUND

Lignocellulosic-based composites, such as wood composites, are used in a variety of applications, including construction, furniture, flooring, and doors. Lignocellulosic-based composites comprise lignocellulosic materials, and sometimes other materials, that are held together with an adhesive. Traditionally, the adhesives used to form lignocellulosic-based composites have contained formaldehyde. For example, traditional adhesives include phenol-formaldehyde (PF) resins and urea-formaldehyde (UF) resins. However, formaldehyde-containing adhesives may release undesirable volatile organic compounds (VOCs) and are made from petroleum derived products.

To address the aforementioned issues, formaldehyde-free adhesives have been developed. Certain formaldehyde-free adhesives are based on a plant or animal protein component, such as soy protein (i.e. protein-based adhesives). Protein components are more abundant than petroleum, come from a renewable source, and exhibit minimal VOC release. However, protein-based adhesives tend to have lower water resistance than formaldehyde-based adhesives. Some existing protein-based adhesives contain an azetidinium functionalized polymer, such as polyamidoamine-epichlorohydrin (PAE), as a formaldehyde-free curing agent. However, adhesives containing a plant or animal protein and an azetidinium functionalized polymer may achieve insufficient adhesion, especially when used in combination with certain lignocellulosic materials having high pitch content, such as material derived from southern yellow pine (SYP).

To improve the bonding strength of the protein-based adhesives, an isocyanate, such as hexamethylene diisocyanate (HDI), is sometimes added to the adhesive, as described in U.S. Pat. No. 8,845,851 B2. However, isocyanates require special processing procedures, present handling challenges, and may compromise the shelf life of the adhesives.

Accordingly, it is desirable to provide novel formaldehyde-free adhesives that achieve maximized adhesion and water resistance when used in combination with lignocellulosic materials to form composite articles, while exhibiting advantageous handling characteristics and maximized shelf life. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Adhesive compositions, methods of forming the adhesive compositions, composite articles comprising cured adhesives formed from the adhesive compositions, and methods of forming the composite articles are provided herein. In an embodiment, an adhesive composition comprises a protein component, an azetidinium functionalized polymer, and an alkylene (meth)acrylic acid copolymer. The adhesive composition is substantially free of formaldehyde.

In another embodiment, a method of forming an adhesive composition that is substantially free of formaldehyde comprises combining, in any order, a protein component, an azetidinium functionalized polymer, and an alkylene (meth)acrylic acid copolymer.

In another embodiment, a method of forming a composite article comprises providing a lignocellulosic material; applying a protein component, an azetidinium functionalized polymer, and an alkylene (meth)acrylic acid copolymer to the lignocellulosic material to form a lignocellulosic material/adhesive combination; and subjecting the lignocellulosic material/adhesive combination to heat and pressure to form the composite article.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Adhesive compositions, methods of forming the adhesive compositions, composite articles comprising cured adhesives formed from the adhesive compositions, and methods of forming the composite articles are provided herein. In an embodiment, an adhesive composition comprises a protein component, an azetidinium functionalized polymer, and an alkylene (meth)acrylic acid copolymer. The adhesive composition is substantially free of formaldehyde. In accordance with the present disclosure, the adhesive compositions contemplated herein exhibit maximized adhesion properties when used in combination with a lignocellulosic material to form a composite article, while exhibiting advantageous handling characteristics and maximized shelf life. In particular, it has been found that composite articles comprising cured adhesive formed from the adhesive composition containing the alkylene (meth)acrylic acid copolymer in combination with the protein component and the azetidinium functionalized polymer exhibits improved wet shear strength and three-cycle soak performance as compared to the wet shear strength and three-cycle soak performance of a composite article comprising a cured adhesive formed from a comparative adhesive composition that contains a protein component and an azetidinium functionalized polymer but not an alkylene (meth)acrylic acid copolymer. Furthermore, these performance parameters are achieved without the need for isocyanates in the adhesive composition.

Unless specifically stated or obvious from context, as used herein, the term “about” is understood as within a range of normal tolerance in the art measured using standard measurement devices for a given measurement, for example within 2 standard deviations of the mean for a particular measurement device. For example, “about” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, “substantially free” means less than 1 wt %, alternatively trace amounts that may be present but not intended, alternatively no detectable presence.

As used herein, “(meth)acryl” is a shorthand term referring to “acryl” and/or “methacryl.” Thus, the term “(meth)acrylate” refers collectively to acrylate and methacrylate.

As used herein, an “adhesive composition” refers to a formulation containing all the components as described herein, including appreciable amounts of solvent (e.g. at least 10 wt %) to facilitate application of the adhesive composition to a lignocellulosic material, and before intended reaction of any of the recited components with moieties on the other recited components or on the lignocellulosic material. An adhesive composition may be, for example, a solution or a dispersion.

The protein component is included in the adhesive compositions provided herein because proteins can provide strong adhesive properties, and especially because proteins can provide the adhesive properties in the absence of formaldehyde. Proteins may readily interact with other molecules through covalent bonding, hydrogen bonding, and/or electrostatic attractions. At the same time, proteins are biodegradable, can be sourced from renewable natural resources, and do not release unwanted byproducts.

In embodiments, the protein component is selected from the group of soy protein, casein, blood meal, feather meal, keratin, gelatin, collagen, gluten, wheat gluten or protein, whey protein, zein or corn protein, rapeseed meal, sunflower meal, or combinations thereof. In embodiments, the protein component is a plant-based protein. In embodiments, the protein component is soy protein obtained from a source selected from soy flour, soy protein concentrate, soy protein isolate, soy meal, toasted soy, or combinations thereof. The protein component may be a protein that has been pretreated or modified to improve its solubility, dispersibility, and/or reactivity. The protein component may be solvated, denatured, or dispersed by the addition of urea or non-urea diluents.

In embodiments, the protein component is present in the adhesive composition in an amount of from about 5 wt % to about 60 wt %, alternatively from about 10 wt % to about 50 wt %, alternatively from about 20 wt % to about 50 wt %, alternatively from about 25 wt % to about 45 wt %, based on a total weight of the adhesive composition.

The azetidinium functionalized polymer is included in the adhesive composition as a cross-linker. In embodiments, the azetidinium functionalized polymer has two or more different types of reactive sites that may react through different reaction mechanisms. For example, one type of reactive site may react with functional groups on other molecules of the azetidinium functionalized polymer or with functional groups of the protein (e.g. carboxylic acid and/or amino groups). The other type of reactive site may react to form covalent bonds with a lignocellulosic material or may form hydrogen bonds with a lignocellulosic material. Accordingly, the azetidinium functionalized polymer may promote covalent bonding between the protein component and a lignocellulosic material.

As used herein, an “azetidinium functionalized polymer” refers to a polymer having at least one repeating unit that contains an azetidinium functional group. The azetidinium functionalized polymer may be a homopolymer or a copolymer. In embodiments, the azetidinium functionalized polymer contains an additional amine group different from the azetidinium group. In embodiments, the azetidinium functionalized polymer is free of additional reactive moieties beyond those described herein. In embodiments, the azetidinium functionalized polymer is selected from amine-epichlorohydrin polymer, polyamidoamine-epichlorohydrin polymer, or combinations thereof. In embodiments, the azetidinium functionalized polymer is a thermosetting polymer.

In embodiments, the azetidinium functionalized polymer is present in the adhesive composition in an amount of from about 2 wt % to about 10 wt %, alternatively from about 3 wt % to about 6 wt %, expressed as a weight percentage of dry polymer based on a total weight of the adhesive composition. In embodiments, the weight ratio of the protein component to the azetidinium functionalized polymer in the adhesive composition is from about 1:1 to about 12:1, alternatively from about 2:1 to about 11:1, alternatively from about 3:1 to about 10:1, alternatively from about 4:1 to about 9:1.

The alkylene (meth)acrylic acid copolymer is included in the adhesive compositions to improve the adhesion performance of the adhesive compositions. The alkylene (meth)acrylic acid may contribute to the formation of a tough, water resistant coating upon curing of the adhesive composition. The alkylene (meth)acrylic acid may also exhibit synergistic interactions with the protein component and/or the azetidinium functionalized polymer. Without being bound by theory, it is thought that the alkylene (meth)acrylic acid copolymer decreases the hydrophilicity of a cured adhesive formed from the adhesive composition, thereby increasing the water resistance of the cured adhesive. Further, it is thought that the carboxylate groups in the alkylene (meth)acrylic acid copolymer may react with the azetidinium groups in the azetidinium functionalized polymer during curing of the adhesive composition, increasing the overall crosslink density of the cured adhesive formed from the adhesive composition.

In embodiments, the alkylene (meth)acrylic acid copolymer has a melt flow index from about 0.1 g/10 min to about 10,000 g/10 min, alternatively from about 1 g/10 min to about 5000 g/10 min, as measured in accordance with ASTM D-1238-23A (published November 2023) at a temperature of 190° C. and with a load of 2.16 kg. In embodiments, the (meth)acrylic acid moieties are present in the alkylene (meth)acrylic acid copolymer in an amount of from about 1 acid weight % to about 20 acid weight %, based on total weight of the alkylene (meth)acrylic acid copolymer.

In embodiments, the alkylene (meth)acrylic acid copolymer is free of branching in the alkylene moiety. In embodiments, the alkylene moiety has from 1 to 10 carbon atoms, alternatively from 1 to 4 carbon atoms. In embodiments, the alkylene (meth)acrylic acid copolymer is free from other moieties different from the alkylene moiety and the (meth)acrylic acid moiety. In embodiments, the alkylene (meth)acrylic acid copolymer is selected from methylene acrylic acid copolymer, methylene methacrylic acid copolymer, ethylene acrylic acid copolymer, ethylene methacrylic acid copolymer, propylene acrylic acid copolymer propylene methacrylic acid copolymer, or combinations thereof. In embodiments, the alkylene (meth)acrylic acid copolymer is ethylene acrylic acid copolymer or methylene acrylic acid copolymer. In embodiments, the alkylene (meth)acrylic acid copolymer is present in the adhesive composition in an amount of from about 0.1 wt % to about 5 wt %, alternatively from about 1.0 wt % to about 4 wt %, alternatively from about 1.5 wt % to about 3 wt %, expressed as a weight percentage of dry polymer based on a total weight of the adhesive composition.

In embodiments, the adhesive composition further comprises an aqueous solvent. The aqueous solvent may facilitate application of the composition to a lignocellulosic material. Including an aqueous solvent (e.g. water) in the adhesive composition may contribute to improved handling, storage, and shelf life of the adhesive composition. Aqueous solvents also release fewer volatile organic compounds (VOC) than many organic solvents. In embodiments, the aqueous solvent is present in the adhesive composition in an amount of from about 10 wt % to less than 100 wt %, alternatively from about 30 wt % to about 90 wt %, alternatively from about 50 wt % to about 80 wt %.

The adhesive composition is substantially free of formaldehyde. Formaldehyde-containing compounds may release undesirable VOCs and are made from petroleum derived products. Accordingly, substantially formaldehyde-free adhesive compositions are more likely to comply with regulations and contribute to sustainability. However, without the combination of the alkylene (meth)acrylic acid copolymer, the protein component, and the azetidinium functionalized polymer provided herein, it may not have previously been possible to achieve acceptable adhesion performance with an adhesive composition that is substantially free of formaldehyde.

In embodiments, the adhesive composition is substantially free of an isocyanate. Isocyanates have previously been used to improve the adhesion of adhesive compositions, including adhesive compositions containing a protein component and an azetidinium functionalized polymer. However, it is not desirable to include isocyanates because isocyanates are highly sensitive to water and heat, leading to problems with handling, storage, and shelf life. Isocyanates may also be subject to regulations that require extra steps in the manufacturing process and make it more expensive to use. However, without the combination of the alkylene (meth)acrylic acid copolymer, the protein component, and the azetidinium functionalized polymer provided herein, it may not have previously been possible to achieve acceptable adhesion performance with a substantially formaldehyde-free adhesive composition that is substantially free of isocyanates.

In embodiments, the adhesive composition consists essentially of the protein component, the azetidinium functionalized polymer, and the alkylene (meth)acrylic acid copolymer. As used herein “consisting essentially of” means that the adhesive composition consists of the specified components and only those other components that do not materially affect the basic characteristics of the adhesive composition. As used herein, the “basic characteristics” of the adhesive composition refer to properties of the adhesive composition that contribute to adhesion and water resistance of a cured adhesive formed from the adhesive composition, as evidenced by the wet shear strength and 3-cycle soak performance of a composite article comprising the cured adhesive formed from the adhesive composition.

The methods of forming an adhesive composition provided herein include combining the protein component, the azetidinium functionalized polymer, and the alkylene (meth)acrylic acid copolymer to form the adhesive composition. In embodiments, the protein component and the azetidinium functionalized polymer are combined to form a protein/polymer combination, and the alkylene (meth)acrylic acid copolymer is subsequently combined with the protein/polymer combination to form the adhesive composition. In other embodiments, the protein component and the alkylene (meth)acrylic acid copolymer are combined to form a protein/copolymer combination, and the azetidinium functionalized polymer is subsequently combined with the protein/copolymer combination to form the adhesive composition. The components of the adhesive composition may be combined using any method known in the art. The components may be combined in the form of aqueous solutions or dispersions.

The composite articles provided herein include a lignocellulosic material and a cured adhesive formed from the adhesive compositions provided herein. The lignocellulosic material serves as the base material for the composite article that is adhered together by the adhesive. As used herein, a “lignocellulosic material” refers to plant biomass that includes cellulose and lignin. In embodiments, the lignocellulosic material is in the form of powders, particles, fibers, chips, flakes, fibers, wafers, trim, shavings, stalks, panels, or combinations thereof. In embodiments, the lignocellulosic material is selected from wood veneers, wood fibers, wood flakes, wood strands, wood chips, wood particles, pulp wood, wood wastes, wood bark, sawdust, paper, cellulose-containing fibers of annual plants, granulated biomasses, or combinations thereof. If the lignocellulosic material is a wood material, the wood material may be selected from, for example, pine, poplar, spruce, fir, cedar, oak, maple, birch, ash, or combinations thereof. The type of wood material may affect the adhesion between the lignocellulosic material and the cured adhesive, thus affecting the wet shear strength of the composite article.

The cured adhesive is formed from the adhesive compositions provided herein. As used herein, a “cured adhesive” refers to a dried substance present on a lignocellulosic material. “Dried” refers to containing less than 10 wt % solvent, alternatively less than 1 wt % solvent, based on a total weight of the cured adhesive. The cured adhesive may be a substantially crosslinked thermoset material. The cured adhesive holds pieces of the lignocellulosic material together to give the composite article its structure.

In embodiments, the composite article has a wet shear strength of from about 0.40 N/mm² to about 3.50 N/mm², alternatively from about 0.70 N/mm² to about 2.50 N/mm², alternatively from about 1.75 N/mm² to about 3.50 N/mm², alternatively from about 1.90 N/mm² to about 3.50 N/mm², alternatively from about 1.90 N/mm² to about 3.20 N/mm², as determined using an Automated Bonding Evaluation System immediately after soaking the composite article in water having a temperature of 25° C. for four hours. The recited values for wet shear strength represent acceptable performance for composite articles. Further, the recited values may not have been previously achievable when the cured adhesive was formed form an adhesive composition that is substantially free of formaldehyde. In embodiments, the composite article has a wet shear strength greater than that of a composite article including a lignocellulosic material and a cured adhesive formed from an adhesive composition that contains a protein component and an azetidinium functionalized polymer but does not contain an alkylene (meth)acrylic acid copolymer.

In embodiments, when samples of the composite articles are tested, from about 85% to about 100% of samples exhibit no continuous area of delamination having a length of greater than 2 inches and a depth of greater than 0.25 inches, as determined by visual observation after the composite article undergoes three cycles of soaking in water having a temperature of 25° C. for four hours and drying in an environment having a temperature of 50° C. for 19 hours (i.e. 3-cycle soak performance), as described in ANSI-HPVA HP-1-2009, section 4.6. The recited values for 3-cycle soak performance represent acceptable performance for composite articles. Further, the recited values may not have been previously achievable when the cured adhesive was formed from an adhesive composition that is substantially free of formaldehyde.

The methods of forming the composite articles provided herein include providing the lignocellulosic material; applying the protein component, the azetidinium functionalized polymer, and the alkylene (meth)acrylic acid copolymer to the lignocellulosic material to form a lignocellulosic material/adhesive combination; and subjecting the lignocellulosic material/adhesive combination to heat and pressure to form the composite article. In embodiments, the protein component, the azetidinium functionalized polymer, and the alkylene (meth)acrylic acid copolymer are combined, and the combination is applied to the lignocellulosic material. In other embodiments, the alkylene (meth)acrylic acid is applied to the lignocellulosic material, and then a combination of the protein component and the azetidinium functionalized material are applied to the lignocellulosic material. The protein component, the azetidinium functionalized polymer, and the alkylene (meth)acrylic acid copolymer may be applied to the lignocellulosic material using any method known in the art. In embodiments, the adhesive composition containing the protein component, the azetidinium functionalized polymer, and the alkylene (meth)acrylic acid copolymer is applied to the lignocellulosic material in an amount of from about 10 grams to about 30 grams, alternatively from about 15 grams to about 25 grams, of adhesive composition per square foot of surface area of the lignocellulosic material.

In embodiments, the lignocellulosic material/adhesive combination is subjected to a temperature of from about 50° C. to about 200° C., alternatively from about 75° C. to about 150° C. In embodiments, the lignocellulosic material/adhesive combination is subjected to a pressure of from about 500 kPa to about 1000 kPa, alternatively from about 600 kPa to about 950 kPa. The lignocellulosic material/adhesive combination may be subjected to heat and pressure simultaneously, or the lignocellulosic material/adhesive combination may be subject to heat and pressure separately. The heat and pressure may be applied using any known method, for example with a hot press.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

### EXAMPLES

### Examples 1-12

Adhesive compositions were prepared in accordance with this disclosure. For each of Examples 1-12, soy flour, polyamidoamine-epichlorohydrin, and ethylene acrylic acid copolymer were combined and mixed to form the adhesive composition. The specific components and amounts present in the adhesive compositions of each of Examples 1-12 are shown in Table 1 below.

TABLE 1
Components of Adhesive Compositions for Examples 1-12

| | | Weight ratio | | Amount | Amount |
|---|---|---|---|---|---|
| | Type | of soy flour | Type | of EAA | of HDI |
| Example | of PAE | to PAE | of EAA | (wt %) | (wt %) |
| Example 1 | PAE 1 | 5:1 | EAA 1 | 1.59% | 0% |
| Example 2 | PAE 1 | 8:1 | EAA 1 | 1.59% | 0% |
| Example 3 | PAE 1 | 5:1 | EAA 1 | 3.05% | 0% |
| Example 4 | PAE 1 | 8:1 | EAA 1 | 3.05% | 0% |
| Example 5 | PAE 2 | 5:1 | EAA 1 | 1.59% | 0% |
| Example 6 | PAE 2 | 8:1 | EAA 1 | 1.59% | 0% |
| Example 7 | PAE 2 | 5:1 | EAA 1 | 3.05% | 0% |
| Example 8 | PAE 2 | 8:1 | EAA 1 | 3.05% | 0% |
| Example 9 | PAE 1 | 5:1 | EAA 2 | 1.59% | 0% |
| Example 10 | PAE 1 | 8:1 | EAA 2 | 1.59% | 0% |
| Example 11 | PAE 1 | 5:1 | EAA 2 | 3.05% | 0% |
| Example 12 | PAE 1 | 8:1 | EAA 2 | 3.05% | 0% |

In Table 1 above, PAE 1 is a polyamidoamine-epichlorohydrin resin commercially available from Hercules Incorporated under the trade name Hercules™ CA2925.

PAE 2 is a polyamidoamine-epichlorohydrin resin commercially available from Hercules Incorporated under the trade name Hercules™ CA1130.

EAA 1 is an ethylene acrylic acid copolymer commercially available from Paramelt B.V. under the trade name Aquaseal™ 2155.

EAA 2 is an ethylene acrylic acid copolymer produced for internal use only by Solenis, LLC, Wilmington, DE under the trade name DPT-1036. EAA 2 has a lower molecular weight than EAA 1.

The amount of EAA is expressed as a dry weight percentage of EAA present in the adhesive composition based on a total weight of the adhesive composition.

### Comparative Examples 1-6

Comparative Examples 1-6 are comparative examples not in accordance with this disclosure. For each of Comparative Examples 1-4, soy flour and polyamidoamine-epichlorohydrin were combined and mixed to form the adhesive composition. For each of Comparative Examples 5-6, soy flour, polyamidoamine-epichlorohydrin, and hexamethylene diisocyanate were combined and mixed to form the adhesive composition. The specific components and amounts present in the adhesive compositions of each of Comparative Examples 1-6 are shown in Table 2 below.

TABLE 2
Components of Adhesive Compositions
for Comparative Examples 1-6

| | | Weight ratio | | |
|---|---|---|---|---|
| | Type | of soy flour | Amount of | Amount of |
| Example | of PAE | to PAE | EAA (wt %) | HDI (wt %) |
| Comparative | PAE 1 | 5:1 | 0% | 0% |
| Example 1 | | | | |
| Comparative | PAE 1 | 8:1 | 0% | 0% |
| Example 2 | | | | |
| Comparative | PAE 2 | 5:1 | 0% | 0% |
| Example 3 | | | | |
| Comparative | PAE 2 | 8:1 | 0% | 0% |
| Example 4 | | | | |
| Comparative | PAE 2 | 5:1 | 0% | 1% |
| Example 5 | | | | |
| Comparative | PAE 2 | 8:1 | 0% | 1% |
| Example 6 | | | | |

In Table 2 above, the HDI is hexamethylene diisocyanate.

The amount of HDI is expressed as a dry weight percentage of HDI present in the adhesive composition based on a total weight of the adhesive composition.

### Examples 13-20

For each of Examples 13-20, ten samples of the adhesive composition indicated in Table 3 below were pressed on a maple substrate to form a composite article. Each composite article was conditioned for 18 hours.

TABLE 3
Adhesive Compositions Used for Composite
Articles of Examples 9-16

| Example | Adhesive Composition Used to Form Composite Article |
|---|---|
| Example 13 | Adhesive Composition of Example 1 |
| Example 14 | Adhesive Composition of Example 2 |
| Example 15 | Adhesive Composition of Example 3 |
| Example 16 | Adhesive Composition of Example 4 |
| Example 17 | Adhesive Composition of Example 5 |
| Example 18 | Adhesive Composition of Example 6 |
| Example 19 | Adhesive Composition of Example 7 |
| Example 20 | Adhesive Composition of Example 8 |

### Comparative Examples 7-12

For each of Comparative Examples 7-12, ten samples of the adhesive composition indicated in Table 4 below were pressed on a maple substrate to form a composite article. Each composite article was conditioned for 18 hours.

TABLE 4
Adhesive Compositions Used for Composite
Articles of Comparative Examples 7-12

| Example | Adhesive Composition Used to Form Composite Article |
|---|---|
| Comparative Example 7 | Adhesive Composition of Comparative Example 1 |
| Comparative Example 8 | Adhesive Composition of Comparative Example 2 |
| Comparative Example 9 | Adhesive Composition of Comparative Example 3 |
| Comparative Example 10 | Adhesive Composition of Comparative Example 4 |
| Comparative Example 11 | Adhesive Composition of Comparative Example 5 |
| Comparative Example 12 | Adhesive Composition of Comparative Example 6 |

For each of Examples 13-20 and Comparative Examples 7-12, the composite articles were soaked in water at a temperature of 25° C. for four hours. The wet samples were tested for wet shear strength using the Automated Bonding Evaluation System (ABES). The average measured wet shear strength for each of Examples 13-20 and Comparative Examples 7-12 is shown below in Table 5 and Table 6, respectively. The reported values for wet shear strength in the Examples are approximate values.

TABLE 5
Wet Shear Strength of Composite Articles for Examples 13-20

| Example | Wet Shear Strength (N/mm²) |
|---|---|
| Example 13 | 2.60 |
| Example 14 | 2.10 |
| Example 15 | 3.00 |
| Example 16 | 2.40 |
| Example 17 | 2.25 |
| Example 18 | 2.10 |
| Example 19 | 2.40 |
| Example 20 | 1.90 |

TABLE 6
Wet Shear Strength of Composite Articles
for Comparative Examples 7-12

| Example | Wet Shear Strength (N/mm²) |
|---|---|
| Comparative Example 7 | 2.50 |
| Comparative Example 8 | 2.20 |
| Comparative Example 9 | 2.05 |
| Comparative Example 10 | 1.70 |
| Comparative Example 11 | 2.00 |
| Comparative Example 12 | 1.90 |

The results in Tables 5 and 6 show that the wet shear strength of a composite article formed from an adhesive composition containing EAA in addition to soy flour and PAE (i.e. Examples 9-16) is higher than that of a composite article formed from an adhesive composition containing soy flour and PAE but not EAA or HDI (i.e. Comparative Examples 7-10), and the same as or higher than that of a composite article formed from an adhesive composition containing soy flour, PAE, and HDI but no EAA (i.e. Comparative Examples 11-12).

### Examples 21-38

For Examples 21-38, composite articles were prepared by applying the adhesive compositions indicated below in Table 7 to 3-ply wood panels indicated below in Table 7. The adhesive composition was applied to each panel in an amount of 19.0 grams of adhesive composition per square foot of the surface of the panel. The coated panels were allowed to stand for ten minutes. The coated panels were pressed for five minutes at a temperature of 25° C. and a pressure of 690 kPa, and then pressed for three minutes at a temperature of 125° C. and a pressure of 900 kPa to form the composite articles.

TABLE 7
Adhesive Compositions and Wood Panels Used to
Form Composite Articles of Examples 21-38

| | | 3-Ply Wood |
|---|---|---|
| Example | Adhesive Composition | Panel |
| Example 21 | Adhesive Composition of Example 1 | Poplar |
| Example 22 | Adhesive Composition of Example 1 | Pine |
| Example 23 | Adhesive Composition of Example 2 | Poplar |
| Example 24 | Adhesive Composition of Example 2 | Pine |
| Example 25 | Adhesive Composition of Example 3 | Poplar |
| Example 26 | Adhesive Composition of Example 3 | Pine |
| Example 27 | Adhesive Composition of Example 4 | Poplar |
| Example 28 | Adhesive Composition of Example 4 | Pine |
| Example 29 | Adhesive Composition of Example 5 | Poplar |
| Example 30 | Adhesive Composition of Example 5 | Pine |
| Example 31 | Adhesive Composition of Example 9 | Poplar |
| Example 32 | Adhesive Composition of Example 9 | Pine |
| Example 33 | Adhesive Composition of Example 10 | Poplar |
| Example 34 | Adhesive Composition of Example 10 | Pine |
| Example 35 | Adhesive Composition of Example 11 | Poplar |
| Example 36 | Adhesive Composition of Example 11 | Pine |
| Example 37 | Adhesive Composition of Example 12 | Poplar |
| Example 38 | Adhesive Composition of Example 12 | Pine |

### Comparative Examples 13-18

For Comparative Examples 13-18, the procedure described above for Examples 21-38 was used, except that the adhesive compositions and 3-ply wood panels shown below in Table 8 were used.

TABLE 8
Adhesive Compositions and Wood Panels Used to Form
Composite Articles of Comparative Examples 13-18

| | | 3-Ply |
|---|---|---|
| Example | Adhesive Composition | Wood Panel |
| Comparative | Adhesive Composition of | Poplar |
| Example 13 | Comparative Example 1 | |
| Comparative | Adhesive Composition of | Pine |
| Example 14 | Comparative Example 1 | |
| Comparative | Adhesive Composition of | Poplar |
| Example 15 | Comparative Example 2 | |
| Comparative | Adhesive Composition of | Pine |
| Example 16 | Comparative Example 2 | |
| Comparative | Adhesive Composition of | Poplar |
| Example 17 | Comparative Example 3 | |
| Comparative | Adhesive Composition of | Pine |
| Example 18 | Comparative Example 3 | |

For each of Examples 21-38 and Comparative Examples 13-18, the composite articles were tested for wet shear strength as described above for Examples 13-20 and Comparative Examples 7-12, except that the wet shear strength of the composite articles was tested in two different orientations: “open” and “closed,” as described in ASTM standard D906-98, section 9.1. The composite articles of Examples 21-38 and Comparative Examples 13-18 were also tested for 3-cycle soak performance as described in ANSI-HPVA HP-1-2009, section 4.6. Each composite article underwent three cycles of soaking in water having a temperature of 25° C. for four hours and drying in an environment having a temperature of 50° C. for 19 hours. Then, the composite articles were visually observed, and the area of delamination observed on each composite article was recorded. The 3-cycle soak pass percentage was calculated by determining the number of samples that passed for each Example and dividing the number of passing samples by 8 (total number of samples per panel) and multiplying the result by 100. Any sample that exhibited no continuous area of delamination having a length of greater than 2 inches and a depth of greater than 0.25 inches was considered to be a passing sample. The results of the testing for Examples 21-38 and Comparative Examples 13-18 are shown below in Table 9 and Table 10, respectively. The reported values for 3-cycle soak performance in the Examples are approximate values.

TABLE 9
Wet Shear Strength and 3-Cycle Soak Performance
for Composite Articles of Examples 21-38

| | | | 3-Cycle |
|---|---|---|---|
| | Open Wet Shear | Closed Wet Shear | Soak Pass |
| Example | Strength (N/mm²) | Strength (N/mm²) | Percentage |
| Example 21 | 0.76 | 1.24 | 100% |
| Example 22 | 0.66 | 0.93 | 89% |
| Example 23 | 0.76 | 1.31 | 100% |
| Example 24 | 0.83 | 1.03 | 100% |
| Example 25 | 0.83 | 1.58 | 100% |
| Example 26 | 0.83 | 1.09 | 100% |
| Example 27 | 0.83 | 1.52 | 100% |
| Example 28 | 0.84 | 1.02 | 88% |
| Example 29 | 0.66 | 1.24 | 100% |
| Example 30 | 0.56 | 0.98 | 100% |
| Example 31 | 0.72 | 1.31 | 56% |
| Example 32 | 0.79 | 1.08 | 100% |
| Example 33 | 0.72 | 1.14 | 67% |
| Example 34 | 0.62 | 0.98 | 55% |
| Example 35 | 0.83 | 1.24 | 78% |
| Example 36 | 0.83 | 0.99 | 88% |
| Example 37 | 0.86 | 1.55 | 100% |
| Example 38 | 0.74 | 1.10 | 67% |

TABLE 8
Wet Shear Strength and 3-Cycle Soak Performance for
Composite Articles of Comparative Examples 13-14

| | Open Wet | Closed Wet | 3-Cycle Soak |
|---|---|---|---|
| | Shear Strength | Strength | Pass |
| Example | (N/mm²) | (N/mm²) | Percentage |
| Comparative | 0.72 | 1.21 | 45% |
| Example 13 | | | |
| Comparative | 0.90 | 1.14 | 45% |
| Example 14 | | | |
| Comparative | 0.79 | 1.41 | 100% |
| Example 15 | | | |
| Comparative | 0.66 | 0.83 | 33% |
| Example 16 | | | |
| Comparative | 0.59 | 0.98 | 67% |
| Example 17 | | | |
| Comparative | 0.45 | 0.60 | 45% |
| Example 18 | | | |

The results in Tables 9 and 10 show that, in general, the wet shear strength and 3-cycle soak performance of a composite article formed from an adhesive composition containing EAA in addition to soy flour and PAE is the same or higher than that of a composite article formed from an adhesive composition containing soy flour and PAE but not EAA.

### Examples 39-41

For Examples 39-41, adhesive compositions in accordance with this disclosure were prepared according to the procedure described above for Examples 1-12, using the components shown below in Table 11.

TABLE 11
Components of Adhesive Compositions for Examples 39-41

| | Type | Weight ratio | Type | Amount | Amount |
|---|---|---|---|---|---|
| | of | of soy flour to | of | of EAA | of HDI |
| Example | PAE | PAE | EAA | (wt %) | (wt %) |
| Example 39 | PAE 2 | 8:1 | EAA 1 | 0.83% | 0% |
| Example 40 | PAE 2 | 8:1 | EAA 1 | 1.63% | 0% |
| Example 41 | PAE 2 | 8:1 | EAA 1 | 2.40% | 0% |

In Table 11, the wt % for EAA and HDI represents the weight percentage of the respective component present in the adhesive composition based on a total weight of the adhesive composition.

### Examples 42-44

For Examples 42-44, composite articles in accordance with this disclosure were prepared according to the procedure described above for Examples 21-38, except that the wood panels for Examples 42-44 were 5-ply samples with poplar-pine-pine-pine-poplar construction, so they were hot-pressed for 5.5 minutes rather than 3 minutes. For each of Examples 42-44, the adhesive composition shown in Table 13 below was used.

TABLE 13
Adhesive Compositions Used to Form
Composite Articles of Examples 42-44

| Example | Adhesive Composition |
|---|---|
| Example 42 | Adhesive Composition of Example 39 |
| Example 43 | Adhesive Composition of Example 40 |
| Example 44 | Adhesive Composition of Example 41 |

### Comparative Examples 19-20

For Comparative Examples 19-20, comparative composite articles not in accordance with this disclosure were prepared according to the procedure described above for Comparative Examples 13-18, except that the wood panels for Comparative Examples 19-20 were 5-ply samples with poplar-pine-pine-pine-poplar construction so they were hot-pressed for 5.5 minutes rather than 3 minutes. For each of Comparative Examples 19-20, the adhesive composition shown in Table 14 below was used.

TABLE 14
Adhesive Compositions and Wood Panels Used to Form
Composite Articles of Comparative Examples 19-20

| Example | Adhesive Composition |
|---|---|
| Comparative | Adhesive Composition of |
| Example 19 | Comparative Example 2 |
| Comparative | Adhesive Composition of |
| Example 20 | Comparative Example 4 |

For each of Examples 42-44 and Comparative Examples 19-20, 3-cycle soak performance was tested using the procedure described above for Examples 21-38 and Comparative Examples 13-18. The results are shown below in Tables 15 and 16.

TABLE 15
3-Cycle Soak Performance for Composite
Articles of Examples 42-44

| Example | 3-Cycle Soak Pass Percentage |
|---|---|
| Example 42 | 48% |
| Example 43 | 48% |
| Example 44 | 95% |

TABLE 16
3-Cycle Soak Performance for Composite Articles of
Comparative Examples 19-20

| Example | 3-Cycle Soak Pass Percentage |
|---|---|
| Comparative | 38% |
| Example 19 | |
| Comparative | 81% |
| Example 20 | |

For each of Examples 42-44 and Comparative Examples 19-20, the samples were also evaluated for dry bonding strength. For each Example, a total of 60 bond lines were evaluated, and the average score was calculated by adding together the score for each bond line and dividing by 60. Each composite article was tested by manually separating the veneers using a chisel and assigning a qualitative score based on the difficulty of peeling the veneers and the overall wood failure in doing so. Scores were assigned on a scale of 1 to 5, with a score of 1 representing the worst performance, a score of 5 representing the best performance, and a score of 4 or 5 representing a passing score. The results are shown below in Tables 17 and 18.

TABLE 17
Dry Bonding Results for Composite
Articles of Examples 42-44

| Example | Average Dry Bonding Score |
|---|---|
| Example 42 | 4.62 |
| Example 43 | 4.69 |
| Example 44 | 4.58 |

TABLE 18
Dry Bonding Results for Composite Articles
of Comparative Examples 19-20

| Example | Average Dry Bonding Score |
|---|---|
| Comparative Example 19 | 4.26 |
| Comparative Example 20 | 4.70 |

The results in Tables 15-18 show that in general, adding EAA to an adhesive composition containing soy flour and PAE tends to increase both the wet bonding performance and the dry bonding performance of composite articles formed from the adhesive composition as compared to that of composite articles formed from the adhesive composition containing soy flour and PAE but not EAA.

### Examples 45-56

For each of Examples 45-56, adhesive compositions in accordance with this disclosure were prepared according to the procedure described above for Examples 1-12, using the components shown below in Table 19.

TABLE 19
Components of Adhesive Compositions for Examples 45-56

| | | Weight | Type of | Amount of |
|---|---|---|---|---|
| | Type | ratio of soy | (meth)acrylic | (meth)acrylic |
| | of | flour to | acid | acid copolymer |
| Example | PAE | PAE | copolymer | (wt %) |
| Example 45 | PAE 2 | 8:1 | EAA 3 | 0.81% |
| Example 46 | PAE 2 | 8:1 | EAA 3 | 1.59% |
| Example 47 | PAE 2 | 8:1 | EAA 4 | 0.81% |
| Example 48 | PAE 2 | 8:1 | EAA 4 | 1.59% |
| Example 49 | PAE 2 | 8:1 | EAA 5 | 0.81% |
| Example 50 | PAE 2 | 8:1 | EAA 5 | 1.59% |
| Example 51 | PAE 2 | 8:1 | EAA 6 | 0.81% |
| Example 52 | PAE 2 | 8:1 | EAA 6 | 1.59% |
| Example 53 | PAE 2 | 8:1 | EMA1 | 0.81% |
| Example 54 | PAE 2 | 8:1 | EMA1 | 1.59% |
| Example 55 | PAE 2 | 8:1 | EAA 1 | 0.81% |
| Example 56 | PAE 2 | 8:1 | EAA 1 | 1.59% |

In Table 19, EAA 3 is an ethylene acrylic acid copolymer commercially available from SNP, Durham, NC, under the trade name S-1914-L.

EAA 4 is an ethylene acrylic acid copolymer commercially available from Michelman, Cincinnati, OH, under the trade name MFHS9105.

EAA 5 is an ethylene acrylic acid copolymer commercially available from Michelman, Cincinnati, OH, under the trade name MP 4983R.

EAA 6 is an ethylene acrylic acid copolymer commercially available from Michelman, Cincinnati, OH, under the trade name MP6121.

EMA 1 is an ethylene methacrylic acid copolymer commercially available from Paramelt B. V., Netherlands under the trade name Aquaseal 2393.

### Examples 57-68

For each of Examples 57-68, composite articles in accordance with this disclosure were prepared according to the procedure described above for Examples 21-38, except that all the wood panels for Examples 57-68 were 3-ply pine panels. For each of Examples 57-68, the adhesive composition shown in Table 20 below was used.

TABLE 20
Adhesive Compositions Used to Form
Composite Articles of Examples 57-68

| Example | Adhesive Composition |
|---|---|
| Example 57 | Adhesive Composition of Example 45 |
| Example 58 | Adhesive Composition of Example 46 |
| Example 59 | Adhesive Composition of Example 47 |
| Example 60 | Adhesive Composition of Example 48 |
| Example 61 | Adhesive Composition of Example 49 |
| Example 62 | Adhesive Composition of Example 50 |
| Example 63 | Adhesive Composition of Example 51 |
| Example 64 | Adhesive Composition of Example 52 |
| Example 65 | Adhesive Composition of Example 53 |
| Example 66 | Adhesive Composition of Example 54 |
| Example 67 | Adhesive Composition of Example 55 |
| Example 68 | Adhesive Composition of Example 56 |

### Comparative Examples 21-22

For each of Comparative Examples 21-22, comparative composite articles not in accordance with this disclosure were prepared according to the procedure described above for Comparative Examples 13-18, except that all the wood panels for Comparative Examples 21-22 were 3-ply pine panels. For each of Comparative Examples 21-22, the adhesive composition shown in Table 21 below was used.

TABLE 21
Adhesive Compositions Used to Form Composite
Articles of Comparative Examples 21-22

| Example | Adhesive Composition |
|---|---|
| Comparative | Adhesive Composition of |
| Example 21 | Comparative Example 2 |
| Comparative | Adhesive Composition of |
| Example 22 | Comparative Example 4 |

For each of Examples 57-68 and Comparative Examples 21-22, the 3-cycle soak performance was tested using the procedure described above for Examples 21-38 and Comparative Examples 13-18. the composite articles were tested for open and closed wet shear strength as described above for Examples 21-38 and Comparative Examples 13-18. The results are shown below in Tables 22-23.

TABLE 22
Wet Shear Strength and 3-Cycle Soak Performance
for Composite Articles of Examples 57-68

| | Open Wet | Closed Wet | 3-Cycle Soak |
|---|---|---|---|
| | Shear Strength | Strength | Pass |
| Example | (N/mm²) | (N/mm²) | Percentage |
| Example 57 | 0.43 | 0.62 | 83% |
| Example 58 | 0.55 | 0.81 | 78% |
| Example 59 | 0.59 | 0.76 | 67% |
| Example 60 | 0.55 | 0.74 | 55% |
| Example 61 | 0.66 | 0.76 | 83% |
| Example 62 | 0.59 | 0.93 | 94% |
| Example 63 | 0.59 | 0.90 | 89% |
| Example 64 | 0.52 | 0.76 | 100% |
| Example 65 | 0.53 | 0.68 | 89% |
| Example 66 | 0.64 | 0.88 | 100% |
| Example 67 | 0.57 | 0.74 | 89% |
| Example 68 | 0.52 | 0.69 | 89% |

TABLE 23
Wet Shear Strength and 3-Cycle Soak Performance for
Composite Articles of Comparative Examples 21-22

| | Open Wet | Closed Wet | 3-Cycle Soak |
|---|---|---|---|
| | Shear Strength | Strength | Pass |
| Example | (N/mm²) | (N/mm²) | Percentage |
| Comparative | 0.48 | 0.72 | 17% |
| Example 21 | | | |
| Comparative | 0.56 | 0.93 | 94% |
| Example 22 | | | |

The results in Tables 22-23 show that composite articles formed from an adhesive composition containing soy flour, PAE, and any of the alkylene (meth)acrylic acid copolymers used in the above Examples generally performs better than an adhesive composition containing soy flour and PAE but not an alkylene (meth)acrylic acid copolymer, and may even perform as well as an adhesive composition containing soy flour, PAE, and HDI.

What is claimed is:

1. An adhesive composition comprising:
a protein component;
an azetidinium functionalized polymer; and
an alkylene (meth)acrylic acid copolymer;
wherein the adhesive composition is substantially free of formaldehyde.

2. The adhesive composition of claim 1, wherein the protein component is selected from the group of soy protein, casein, blood meal, feather meal, keratin, gelatin, collagen, gluten, wheat gluten or protein, whey protein, zein or corn protein, rapeseed meal, sunflower meal, or combinations thereof.

3. The adhesive composition of claim 1, wherein the protein component is soy protein obtained from a source selected from soy flour, soy protein concentrate, soy protein isolate, soy meal, toasted soy, or combinations thereof.

4. The adhesive composition of claim 1, wherein the azetidinium functionalized polymer is selected from amine-epichlorohydrin polymer, polyamidoamine-epichlorohydrin polymer, or combinations thereof.

5. The adhesive composition of claim 1, wherein the alkylene (meth)acrylic acid copolymer has a melt flow index of from about 0.1 g/10 min to about 10,000 g/10 min, as measured in accordance with ASTM D-1238-23A (published November 2023) at a temperature of 190° C. and with a load of 2.16 kg.

6. The adhesive composition of claim 1, wherein the (meth)acrylic acid moieties are present in the alkylene (meth)acrylic acid copolymer in an amount of from about 1 acid weight % to about 20 acid weight %, based on total weight of the alkylene (meth)acrylic acid copolymer.

7. The adhesive composition of claim 1, wherein the alkylene (meth)acrylic acid copolymer is selected from methylene acrylic acid copolymer, methylene methacrylic acid copolymer, ethylene acrylic acid copolymer, ethylene methacrylic acid copolymer, propylene acrylic acid copolymer, propylene methacrylic acid copolymer, or combinations thereof.

8. The adhesive composition of claim 1, wherein the weight ratio of the protein component to the azetidinium functionalized polymer is from about 1:1 to about 12:1.

9. The adhesive composition of claim 1, wherein the alkylene (meth)acrylic acid copolymer is present in the adhesive composition in an amount of from about 0.1 wt % to about 5 wt %, based on a total weight of the adhesive composition.

10. The adhesive composition of claim 1, further comprising an aqueous solvent.

11. The adhesive composition of claim 1, wherein the adhesive composition is substantially free of an isocyanate.

12. A composite article comprising:
a lignocellulosic material; and
a cured adhesive formed from the adhesive composition of claim 1.

13. The composite article of claim 12, wherein the lignocellulosic material is selected from wood veneers, wood fibers, wood flakes, wood strands, wood chips, wood particles, pulp wood, wood wastes, wood bark, saw dust, paper, cellulose-containing fibers of annual plants, granulated biomasses, or combinations thereof.

14. The composite article of claim 12, having a wet shear strength of from about 0.40 N/mm² to about 3.50 N/mm², as determined using an Automated Bonding Evaluation System immediately after soaking the composite article in water having a temperature of 25° C. for four hours.

15. The composite article of claim 12, wherein from about 85% to about 100% of samples exhibit no continuous area of delamination having a length of greater than 2 inches and a depth of greater than 0.25 inches, as determined by visual observation after the composite article undergoes three cycles of soaking in water having a temperature of 25° C. for four hours and drying in an environment having a temperature of 50° C. for 19 hours, as described in ANSI-HPVA HP-1-2009, section 4.6.

16. A method of forming an adhesive composition that is substantially free of formaldehyde, the method comprising the steps of:
combining a protein component, an azetidinium functionalized polymer, and an alkylene (meth)acrylic acid copolymer.

17. The method of claim 16, wherein the step of combining the protein component, the azetidinium functionalized polymer, and the alkylene (meth)acrylic acid copolymer comprises:
combining the protein component and the azetidinium functionalized polymer to form a protein/polymer combination, and subsequently combining the alkylene (meth)acrylic acid copolymer with the protein/polymer combination to form the adhesive composition; and/or
combining the protein component and the alkylene (meth)acrylic acid copolymer to form a protein/copolymer combination, and subsequently combining the azetidinium functionalized polymer with the protein/copolymer combination to form the adhesive composition.

18. A method of forming a composite article, the method comprising the steps of:
providing a lignocellulosic material;
applying a protein component, an azetidinium functionalized polymer, and an alkylene (meth)acrylic acid copolymer to the lignocellulosic material to form a lignocellulosic material/adhesive combination; and
subjecting the lignocellulosic material/adhesive combination to heat and pressure to form the composite article.

19. The method of claim 18, wherein the protein component, the azetidinium functionalized polymer, and the alkylene (meth)acrylic acid copolymer are combined, and the combination is applied to the lignocellulosic material.
